(19) United States
(12) Patent Application Publication
(10) Pub. No.: US 2013/0343152 A1
(43) Pub. Date: Dec. 26, 2013

(54) METHOD FOR DETERMINING AN EQUIPMENT CONSTRAINED ACQUISITION DESIGN

(71) Applicant: Conocophillips Company, Houston, TX (US)

(72) Inventors: Shan SHAN, Houston, TX (US); Joel D. BREWER, Houston, TX (US); Peter M. EICK, Houston, TX (US)

(21) Appl. No.: 13/919,507

(22) Filed: Jun. 17, 2013

Related U.S. Application Data
(60) Provisional application No. 61/663,113, filed on Jun. 22, 2012.

(51) Int. Cl. G01V 1/00

(52) U.S. Cl. CPC G01V 1/003
USPC 367/15

(57) ABSTRACT

A method for determining an equipment constrained acquisition design.

### CROSS-REFERENCE TO RELATED APPLICATIONS

This application is a non-provisional application which claims benefit under 35 USC §119(e) to U.S. Provisional Application Ser. No. 61/663,113 filed Jun. 22, 2012, entitled “A METHOD FOR DETERMINING AN EQUIPMENT CONSTRAINED ACQUISITION DESIGN,” which is incorporated herein in its entirety.

### FIELD OF THE INVENTION

This invention relates to a method for determining an equipment constrained acquisition design.

### BACKGROUND OF THE INVENTION

Seismic surveying is used for determining the structure of subterranean strata. Seismic surveying typically uses a seismic energy source, such as airguns, explosive charges or mechanical vibrators, and seismic receivers, such as hydrophones, geophones or accelerometers. The seismic energy source generates acoustic waves which propagate through the subterranean strata and reflect from acoustic impedance differences generally at the interfaces between strata. The reflected waves are detected by the seismic receivers, which generate representative electrical signals. The resulting signals are stored locally and collected later or transmitted by electrical, optical, or radio telemetry to a location where the signals are recorded for later processing and interpretation. The measured travel times of the reflected waves from the source to the receiver locations and the characteristics of the received energy, such as amplitude, provide information concerning the subterranean strata. Seismic surveys are interpreted to determine the most suitable locations for drilling wells for production of hydrocarbons.

The seismic receivers detect noise from many sources known in the art, and detect multiple reflections, as well as the primary reflected waves which are of interest in determining the subsurface structures. The noise and multiple reflections obscure the desired signal and complicate the process of seismic data analysis. A common technique for enhancing the signal-to-noise and primary-to-multiple ratios is the use of multiple different samples of the data. These many samples are called “multi-fold” data. This technique activates the seismic source at a plurality of locations for detection by multiple seismic receivers. The seismic signals received over time are “gathered” by identifying those seismic signals or “traces” corresponding to the same subsurface reflection point, such as a common depth point (CDP) or a common midpoint (CMP). The traces in each CDP/CMP gather are normally “stacked”. Stacking is the process of summing together the traces so that the coherent primary signal is enhanced by in-phase addition while source-generated and ambient noise is attenuated by destructive interference. The number of traces in each common point gather is termed the fold or multiplicity of the data.

Two-dimensional (2-D) seismic surveys typically utilize a simple linear recording geometry. A receiver “group” of one or more receivers is positioned at each receiver station, or location, and the receiver locations are arranged in a single line. The receiver locations are typically equally spaced along the receiver line, giving a constant group interval, or spacing, between receiver locations. The source stations or locations are generally collinear or parallel to the receiver line and by convention are normally spaced between the receivers. Multiple fold data is obtained by moving the source location relative to the receiver line so as to maintain a common depth point for multiple pairs of source and receiver locations. The source locations are typically equally spaced, giving a constant source interval or spacing between source locations.

Three-dimensional (3-D) seismic surveys utilize more complex recording geometries. 3-D recording geometries known in the art typically use multiple nominally parallel receiver lines of seismic receivers, typically with the receiver locations equally spaced along the receiver lines and the receiver lines equally spaced from each other. Source locations are typically positioned along source lines and typically are evenly spaced. The source lines are typically orthogonal to the receiver lines, but may also be parallel to or at a diagonal angle, typically 45 or 22.5 degrees, to the receiver lines. In 3-D surveys, gathers are constructed by taking all seismic traces from an area, referred to as a “bin”, around each common midpoint and assigning the traces to that common midpoint. The areal dimensions of the bin are generally half the group interval by half the source interval. The size of the source interval is independent of the size of the group interval, allowing the use of rectangular bins rather than square bins. Seismic recording methods using these geometries are generally termed “swath” methods. After data are recorded along one swath, one or more of the receiver lines are picked up and replaced on the other side of the recording spread to be used in the next swath, a process termed rolling, rolling along, or rolling over. A uniform fold, in which each rollover develops the same positive integer value for multiplicity, is termed an even fold. Maintaining an even fold constrains the number of receiver lines recorded, the number of receiver lines which are rolled over each time, and the location of sources relative to the receiver spread. Increasing the fold requires increasing the number of receiver lines or decreasing the source line interval, thus increasing the number of source locations. The maximum offset, which depends on the depth of the deepest targets that must be imaged, is the maximum distance between receiver and source in the spread. Maintaining a maximum offset constrains the location of sources relative to the receiver spread. Increasing the maximum offset requires increasing the source spread coverage relative to receiver spread which increases the fold as well.

There is a disadvantage to this kind of 3-D shooting, however, in the excessive amount of equipment required to source on a grid interval equal to twice the desired subsurface resolution. Accordingly, if use of 3-D seismic surveys is to continue to grow, a need exists for new and improved methods that simplify and/or provide economical alternatives that reduce the operational costs of obtaining 3-D seismic survey data.

### SUMMARY OF THE INVENTION

In an embodiment, a method for determining an equipment constrained acquisition design, wherein the method includes: (a) providing a plurality of seismic receiver lines in a parallel arrangement; providing a plurality of seismic sources, wherein the plurality of seismic sources are in range of the plurality of seismic receiver lines; (c) determining the length of each seismic receiver line, wherein the length of each seismic receiver line is substantially similar; (d) determining a seismic receiver line interval, wherein the seismic receiver line interval is the distance between seismic receiver lines; (e) determining a maximum offset, wherein the maximum offset is the distance between the seismic receiver and the seismic source; (f) determining the number of zippers; (g) determining a seismic receiver coverage length, wherein the seismic receiver coverage length is determined by establishing a relationship between the total number of seismic receiver lines, the length of the seismic receiver lines and the number of zippers, wherein the relationship provides

R=imL

in which R=seismic receiver coverage, m=the number of seismic receiver lines, L=the length of the seismic receiver line, and i=the number of zippers; (h) determining the seismic source coverage, wherein the seismic source coverage is determined by establishing a relationship between the length of the seismic receiver lines, the maximum offset, the seismic receiver line intervals, the number of seismic receiver lines, and the number of zippers, wherein the relationship provides

S=(2b+(mi−1)t)(L+(2i−1)b)

in which S=seismic source coverage, b=the maximum offset, and t=the seismic receiver line interval; and (i) determining the seismic source coverage per unit seismic receiver coverage length, wherein the seismic source coverage per unit seismic receiver coverage length is determined by establishing a relationship between the seismic receiver coverage length and the seismic source coverage, wherein the relationship provides

$${a}_{i} = \frac{S}{R}$$

in which a=the seismic source coverage per unit seismic receiver coverage length.

### BRIEF DESCRIPTION OF THE DRAWINGS

The invention, together with further advantages thereof, may best be understood by reference to the following description taken in conjunction with the accompanying drawings in which:

FIG. 1 is a flow chart describing an embodiment of the present invention.

FIG. 2 is a schematic of one swath in accordance with an embodiment of the present invention.

FIG. 3 is a schematic of two zippers in accordance with an embodiment of the present invention.

FIG. 4 is a schematic of three zippers in accordance with an embodiment of the present invention.

FIG. 5 is a schematic of four zippers in accordance with an embodiment of the present invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

The fundamental problem facing the seismic designer given a limited number of receivers and a large surface area to cover is how to roll the equipment from swath to swath. Particularly, this is a problem in marine ocean bottom cable (OBC) and ocean bottom node (OBN) surveys where the number of available channels is limited when compared to land. The designer is typically given two major choices: (1) roll the swath inline or roll the swath crossline and (2) how many zippers or overlaps between swaths are desired. The number of zippers or overlaps is a function of the amount of equipment available and the number of lines of receivers which can be deployed versus the number of zippers needed to complete the survey. The impact of these decisions is the total time to acquire the survey. Because an OBN/OBC crew costs around $1 to $2 per second these decisions have major financial impacts on the total survey costs.

Industry convention is to avoid zippers because they are perceived to take longer than swaths. Most OBN/OBC surveys are designed using this paradigm and approach. The problem is that this is based upon industry convention and not rigorously developed or analyzed.

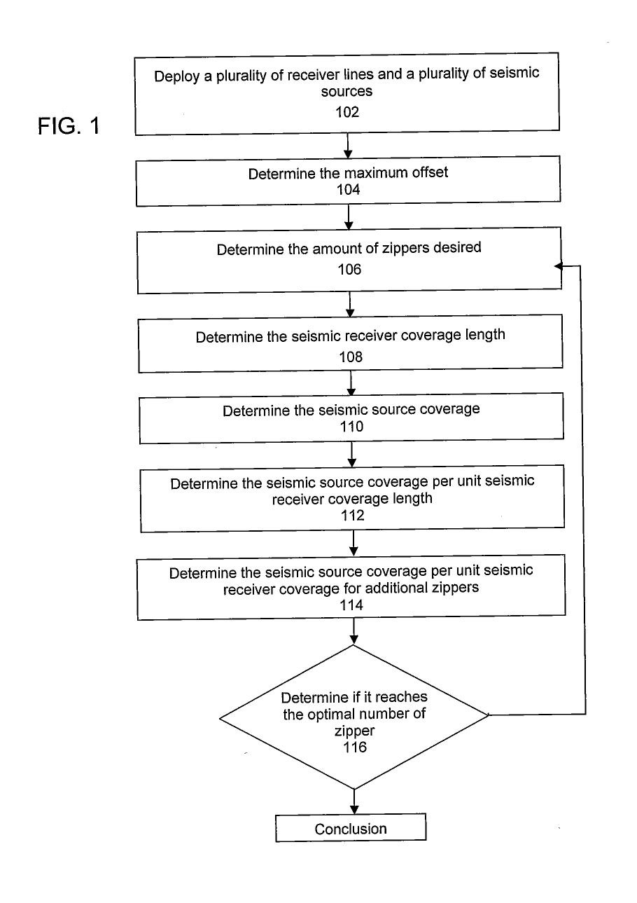

FIG. 1 is a flow chart representing a particular embodiment of the present invention illustrated in FIG. 1. In alternative implementations, the functions noted in the various blocks may occur out of the order depicted in FIG. 1. For example, two blocks shown in succession in FIG. 1 may in fact be executed substantially concurrently, or the blocks may sometimes be executed in the reverse order depending upon the functionality involved.

In step 102, a plurality of receiver lines and a plurality of seismic sources are deployed. The seismic receiver lines are normally deployed in a parallel arrangement. The seismic receiver lines are normally equally spaced apart with substantially similar lengths but in an alternative embodiment, non-equidistant receiver lines can be analyzed. The source lines are normally orthogonal or parallel to the receiver lines.

In step 104, the maximum offset is determined. The maximum offset is the maximum distance between the seismic receiver and the seismic source. The maximum offset is generally a design criteria based upon the geophysical objectives of the survey planned. However, there are many different techniques for determining maximum offset which should be considered before the final determination is made by the survey designer.

In step 106, the amount of zippers desired is determined. Start with one zipper, then gradually increase the number of zippers until the optimum number of zippers is achieved.

In step 108, the seismic receiver coverage length is determined. The seismic receiver coverage length is determined by establishing a relationship between the total number of receiver lines, the length of a single receiver line and the number of zippers:

R=imL

where R=seismic receiver coverage length, m=the number of seismic receiver lines, L=the length of a single seismic receiver line, and i=the number of zippers.

In step 110, the seismic source coverage is determined. The seismic source coverage is determined by establishing a relationship between the length of a single seismic receiver line, the maximum offset, the distance between seismic receiver lines, the number of seismic receiver lines and the number of zippers providing:

S=(2b+(mi−1)t)(L+(2i−1)b)

where S=seismic source coverage, b=the maximum offset, and t=the distance between seismic receiver lines.

In step 112, the seismic source coverage per unit seismic receiver coverage length is determined. The seismic source coverage per unit seismic receiver coverage length is determined by establishing a relationship between the seismic source coverage and the seismic receiver coverage length providing:

$${a}_{i} = \frac{S}{R}$$

where a=the seismic source coverage per unit seismic receiver coverage length.

The durance of a survey is mainly determined by the number of total shots. The cost of an OBN/OBC crew is a linear function with time. Therefore, given a certain amount of equipment, the smallest source coverage which means the least number of total shots is the most cost-efficient survey design. In step 116, based on the criteria, evaluate if the number of zippers reaches the optimal number of zippers, otherwise increase the number of zippers and re-calculate the seismic source coverage per unit seismic receiver coverage length for additional zippers (step 114).

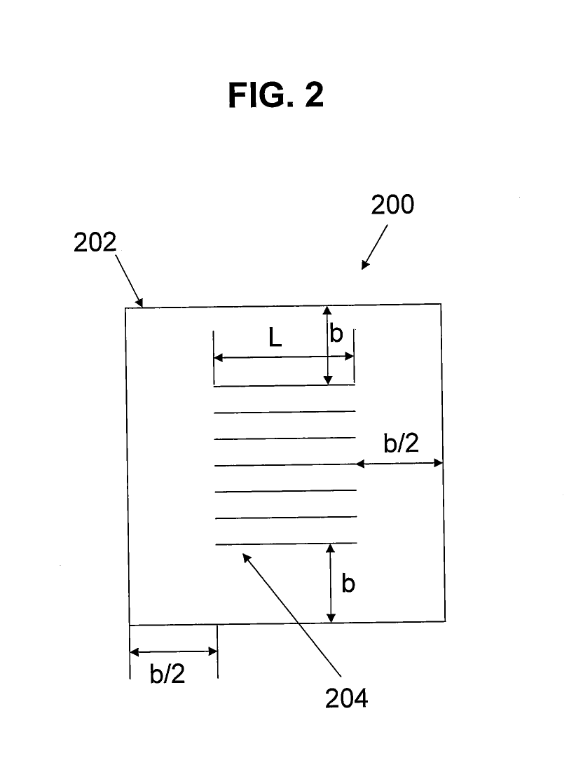

For more in depth analysis, FIGS. 2-5 investigate the use of seismic survey equipment for a plurality of zippers concluding with a universal formula. FIG. 2 depicts a seismic survey containing one swath 200 with a plurality of parallel seismic receiver lines equally spaced with substantially similar lengths, collectively 204. The seismic source coverage is depicted by 202 which extends the receiver coverage about half distance of maximum offsets along the receiver direction and the distance of maximum offset perpendicular to the receiver line direction. The seismic receiver coverage length (R₁) for one swath is determined by establishing a relationship between the number of seismic receiver lines (m) and the length of a single seismic receiver line (L) within a zipper, providing:

R₁=mL

The seismic source coverage (S₁) for one swath is determined by establishing a relationship between the maximum offset (b), the number of seismic receiver lines (m), the distance between receiver lines (t) and the length of the seismic receiver lines (L), providing:

S₁=(2b+(m−1)t)(b+L)

The seismic source coverage per unit seismic receiver coverage (a₁) is determined by establishing a relationship between the seismic source coverage (S₁) for one swath and the seismic receiver coverage length (R₁) for one swath, providing:

$${a}_{i} = \frac{( 2 b + ( m - 1 ) t ) ( b + L )}{m L} = \frac{{S}_{1}}{{R}_{1}}$$

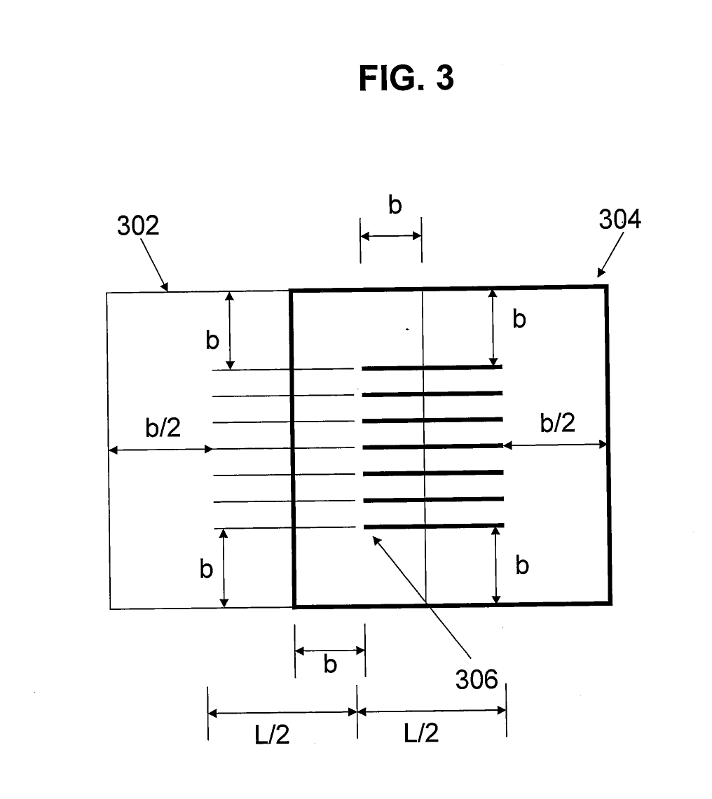

FIG. 3 depicts a seismic survey containing two zippers, 302 and 304, with a plurality of seismic receiver lines equally spaced with substantially similar lengths (L/2), collectively 306. The source coverage should extend the receiver coverage by the distance of maximum offset at the zipper connection side to maintain the same trace characteristics as no-zipper case. Therefore, in FIG. 3, the source coverage for zipper 302 extends the distance of maximum offset beyond the right side of receiver line while the source coverage for 304 extends the distance of maximum offset beyond the left side of receiver line. The seismic receiver coverage length (R₂) for two zippers is determined by establishing a relationship between the number of seismic receiver lines (2m) and the length of a single seismic receiver line within a zipper (L/2), providing:

$${R}_{2} = 2 ( 2 m ( \frac{L}{2} ) ) = 2 m L$$

The seismic source coverage (S₂) for two zippers is determined by establishing a relationship between the maximum offset (b), the number of seismic receiver lines within a zipper (2m), the distance between receiver lines (t) and the length of a single seismic receiver line within a zipper (L/2), providing:

$${S}_{2} = 2 ( ( 2 b + t ( 2 m - 1 ) ) ( \frac{L}{2} + 1.5 b ) )$$

The seismic source coverage per unit seismic receiver coverage length (a₂) is determined by establishing a relationship between the seismic source coverage (S₂) for one swath and the seismic receiver coverage (R₂) for two zippers, providing:

$${a}_{2} = \frac{2 ( ( 2 b + t ( 2 m - 1 ) t ) ( \frac{L}{2} + 1.5 b ) )}{2 m L} = \frac{( 2 b + t ( 2 m - 1 ) ) ( L + 3 b )}{2 m L} = \frac{{S}_{2`}}{{R}_{2}}$$

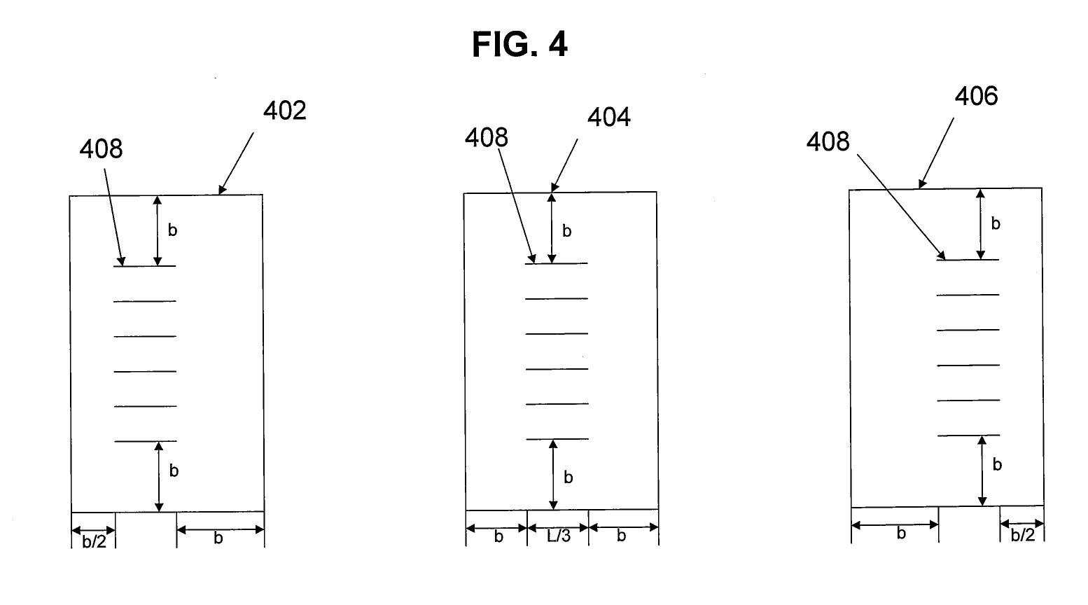

FIG. 4 depicts a seismic survey containing three zippers, 402, 404 and 406, with a plurality of seismic receiver lines equally spaced with substantially similar lengths (L/3), collectively 408. The source coverage has to extend the receiver coverage by the distance of maximum offset at zipper connection sides and extend the receiver coverage by the half of distance of maximum offset at both survey edges to maintain the same maximum offset for the survey. The seismic receiver coverage length (R₃) for three zippers is determined by establishing a relationship between the number of seismic receiver lines within a zipper (3m) and the length of a single seismic receiver line within a zipper (L/3), providing:

$${R}_{3} = 3 ( 3 m ( \frac{L}{3} ) ) = 3 m L$$

The seismic source coverage (S₃₁) for zipper 402 is determined by establishing a relationship between the maximum offset (b), the number of seismic receiver lines within a zipper (3m), the distance between receiver lines (t) and the length of a single seismic receiver line within a zipper (L/3), providing:

$${S}_{31} = ( 2 b + t ( 3 m - 1 ) ) ( \frac{L}{3} + 1.5 b )$$

The seismic source coverage (S₃₂) for zipper 404 is determined by establishing a relationship between the maximum offset (b), the number of seismic receiver lines within a zipper (3m), the distance between receiver lines (t) and the length of a single seismic receiver line within a zipper (L/3), providing:

$${S}_{32} = ( 2 b + t ( 3 m - 1 ) ) ( \frac{L}{3} + 2 b )$$

The seismic source coverage for zipper 406 is symmetrical with the source coverage of zipper 402, thus the seismic source coverage for zipper 406 is:

$${S}_{33} = ( 2 b + t ( 3 m - 1 ) ) ( \frac{L}{3} + 1.5 b )$$

The seismic source coverage per unit seismic receiver coverage length (a₃) is determined by establishing a relationship between the total seismic source coverage (S₃) for one swath and the seismic receiver coverage (R₃) for three zippers, providing:

$${a}_{3} = \frac{{S}_{31} + {S}_{32} + {S}_{33}}{{R}_{3}} = \frac{( 2 b + t ( 3 m - 1 ) ) [ 2 ( \frac{L}{3} + 1.5 b ) + ( \frac{L}{3} + 2 b ) ]}{3 m L} = \frac{( 2 b + t ( 3 m - 1 ) ) ( L + 5 b )}{3 m L} = \frac{{S}_{3}}{{R}_{3}}$$

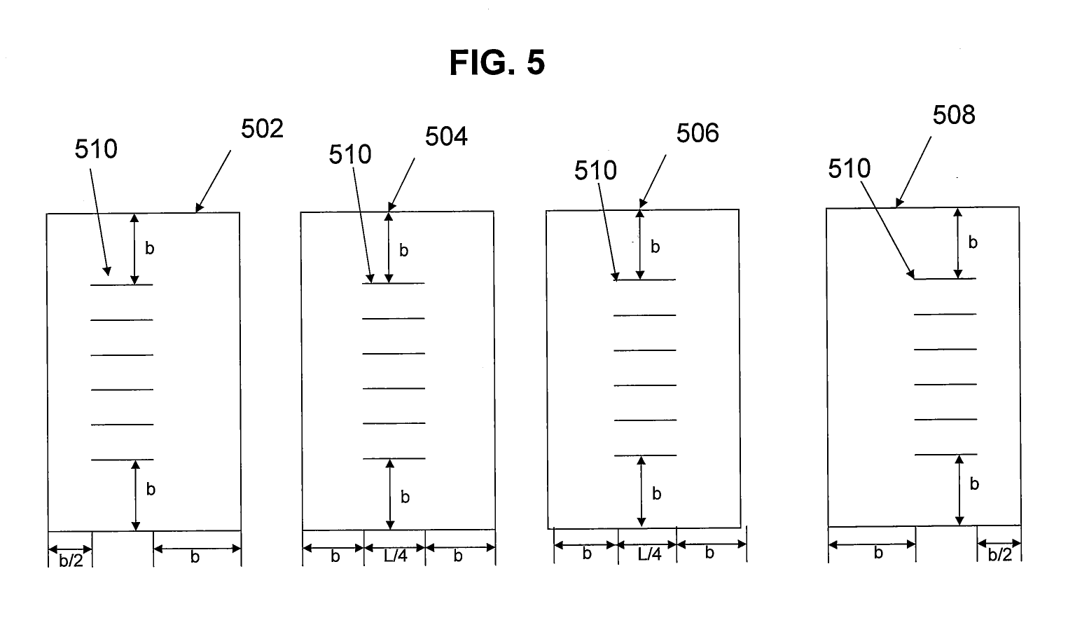

FIG. 5 depicts a seismic survey containing four zippers, 502, 504, 506 and 508, with a plurality of seismic receiver lines equally spaced with substantially similar lengths, collectively 510. The source coverage extends the receiver coverage by the distance of maximum offset at zipper connection sides and extends the receiver coverage by the half of distance of maximum offset at both survey edges. The seismic receiver coverage length (R₄) for three zippers is determined by establishing a relationship between the number of seismic receiver lines within a zipper (4m) and the length of a single seismic receiver line within a zipper (L/4), providing:

$${R}_{4} = 4 ( 4 m ( \frac{L}{4} ) ) = 4 m L$$

The seismic source coverage (S₄₁) for zipper 502 is determined by establishing a relationship between the maximum offset (b), the number of seismic receiver lines within a zipper (4m), the distance between receiver lines (t) and the length of a single seismic receiver line within a zipper (L/4), providing:

$${S}_{41} = ( 2 b + t ( 4 m - 1 ) ) ( \frac{L}{4} + 1.5 b )$$

The seismic source coverage (S₄₂) for zipper 504 is determined by establishing a relationship between the maximum offset (b), the number of seismic receiver lines within a zipper (4m), the distance between receiver lines (t) and the length of a single seismic receiver line within a zipper (L/4), providing:

$${S}_{42} = ( 2 b + t ( 4 m - 1 ) ) ( \frac{L}{4} + 2 b )$$

The seismic source coverage for zipper 506 is symmetrical with the seismic source coverage of zipper 504, thus the seismic source coverage for zipper 506 is:

$${S}_{43} = ( 2 b + t ( 4 m - 1 ) ) ( \frac{L}{4} + 2 b )$$

The seismic source coverage for zipper 508 is symmetrical with the source coverage of zipper 502, thus the seismic source coverage for zipper 508 is:

$${S}_{41} = ( 2 b + t ( 4 m - 1 ) ) ( \frac{L}{4} + 1.5 b )$$

The seismic source coverage per unit seismic receiver coverage length (a₄) is determined by establishing a relationship between the total seismic source coverage (S₄) for one swath and the seismic receiver coverage (R₄) for four zippers, providing:

$${a}_{4} = \frac{{S}_{41} + {S}_{42} + {S}_{43} + {S}_{44}}{{R}_{4}} = \frac{( 2 b + t ( 4 m - 1 ) ) [ 2 ( \frac{L}{4} + 1.5 b ) + 4 ( \frac{L}{4} + 2 b ) ]}{4 m L} = \frac{( 2 b + t ( 4 m - 1 ) ) ( L + 7 b )}{4 m L} = \frac{{S}_{4}}{{R}_{4}}$$

A general equation for seismic source coverage per unit seismic receiver coverage length for the number of zipper (i) is provided as the following:

$${a}_{i} = \frac{( 2 b + t ( im - 1 ) ) ( L + ( 2 i - 1 ) b )}{im L}$$

Given a certain amount of equipment, the smallest source coverage is the most cost-efficient survey design. Therefore, when aᵢ₊₁ [symbol] aᵢ, i is the optimal number of zippers for the survey design. This optimization holds true equally for marine surveys or land surveys when being shot with a limited amount of equipment. In a more general case the distance between receiver lines or the length of the receiver lines or both may not be the same for all receiver lines. The same concept can be applied using more complex formulas or modeling. An approximation can be made for simple non-uniform cases by using an average for the parameters.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method for determining an equipment constrained acquisition design, wherein the method comprises:
a. providing a plurality of seismic receiver lines in a parallel arrangement;
b. providing a plurality of seismic sources, wherein the plurality of seismic sources are in range of the plurality of seismic receiver lines;
c. determining the length of each seismic receiver line;
d. determining a seismic receiver line interval, wherein the seismic receiver line interval is the distance between seismic receiver lines;
e. determining a maximum offset, wherein the maximum offset is the distance between the seismic receiver line and the seismic source;
f. determining the number of zippers;
g. determining a seismic receiver coverage length, wherein the seismic receiver coverage length is determined by establishing a relationship between the total number of seismic receiver lines, the length of the seismic receiver lines and the number of zippers, wherein the relationship provides
R=imL
in which R=seismic receiver coverage, m=the number of seismic receiver lines, L=the length of the seismic receiver line, and i=the number of zippers;
h. determining the seismic source coverage, wherein the seismic source coverage is determined by establishing a relationship between the length of the seismic receiver lines, the maximum offset, the seismic receiver line intervals, the number of seismic receiver lines, and the number of zippers, wherein the relationship provides
S₁=(2b+(m−1)t)(L+(2i−1)b)
in which S=seismic source coverage, b=the maximum offset, and t=the seismic receiver line interval; and
i. determining the seismic source coverage per unit seismic receiver coverage length, wherein the seismic source coverage per unit seismic receiver coverage length is determined by establishing a relationship between the seismic receiver coverage length and the seismic source coverage, wherein the relationship provides
$${a}_{i} = \frac{S}{R}$$
in which a=the seismic source coverage per unit seismic receiver coverage length.

2. The method according to claim 1, wherein the distance between seismic receiver lines, t, is essentially the same for all receiver lines.

3. The method according to claim 1, wherein the distance between seismic receiver lines, t, is a variable distance and t, the seismic receiver line interval becomes the average receiver line interval.

4. The method according to claim 1, wherein the length of the seismic receiver line, L, is essentially the same for all receiver lines.

5. The method according to claim 1, wherein the length of the seismic receiver line, L, is a variable length and L, the length of the seismic receiver line becomes the average receiver line length.

6. The method according to claim 1, wherein the distance between seismic receiver lines, t, is a variable distance and t, the seismic receiver line interval becomes the average receiver line interval and wherein the length of the seismic receiver line, L, is a variable length and L, the length of the seismic receiver line becomes the average receiver line length.

7. The method according to claim 1, wherein the seismic receiver lines are ocean bottom cables.

8. The method according to claim 1, wherein the seismic receiver lines are ocean bottom nodes.

9. The method according to claim 1, wherein the seismic receiver lines are formed by using a land cable based receiver system.

10. The method according to claim 1, wherein the seismic receiver lines are formed by using a land autonomous node receiver system.

11. The method according to claim 1, wherein the seismic receiver lines are formed by a combination of an ocean bottom receiver system and a land receiver system.

12. The method according to claim 1, wherein the length of each seismic receiver line is substantially similar.
